(19) United States
(12) Patent Application Publication
(10) Pub. No.: US 2026/0327930 A1
(43) Pub. Date: Oct. 22, 2026

(54) Mounting for a Port and Port

(71) Applicant: Bruno Sokac, Križevci (HR)

(72) Inventor: Bruno Sokac, Križevci (HR)

(21) Appl. No.: 19/119,500

(22) PCT Filed: Oct. 5, 2023
(86) PCT No.: PCT/EP2023/077599

§ 371 Date: Apr. 9, 2025

(30) Foreign Application Priority Data
Oct. 10, 2022 (DE) 20 2022 105 693.5

(51) Int. Cl. E02B 3/26; B63B 21/06; B63B 27/25; B63B 35/34; E02B 3/06

(52) U.S. Cl. CPC E02B 3/26; B63B 21/06; B63B 27/25; B63B 35/34; E02B 3/064

(57) ABSTRACT

A mounting, in particular a pontoon, for a port, including a platform, a receiving body arranged under the platform, and a boat supply arranged inside the receiving body, in particular for supplying power and/or water to a boat. The invention also relates to a port with said type of mounting.

### CROSS-REFERENCE TO RELATED APPLICATIONS

This application is the United States national phase of International Patent Application No. PCT/EP2023/077599 filed Oct. 5, 2023, and claims priority to German Patent Application No. 20 2022 105 693.5 filed Oct. 10, 2022, the disclosures of which are hereby incorporated by reference in their entireties.

### BACKGROUND OF THE INVENTION

### Field of the Invention

The invention relates to a mounting for a port and a port.

### Description of Related Art

Ports, in particular marinas, have several berths for boats.

In addition, ports are often used to supply the boats. Supply includes, for example, power supply, fresh water supply, waste water removal and/or fuel supply. On the one hand, this supply serves to supply the boats during the stay in the port and/or for past and/or future trips. In particular, the supply includes filling fresh water tanks, fuel tanks and/or batteries of boats. In particular, the supply also includes the removal, preferably discharge or pumping out, of waste water from waste water tanks.

Currently, this type of boat supply generally takes place at central points in the ports. This means that either supply lines, such as cables and/or hoses, must be laid or supply points must be created separately. Central supply points, for example, take up a lot of space and/or the laying of lines is cumbersome and poses a safety risk, e.g. risk of tripping and/or leakage.

Another disadvantage is that the boats are currently generally supplied regardless of consumption, meaning that actual consumption cannot be recorded and, in particular, billed.

### SUMMARY OF THE INVENTION

The object of the invention is to improve the supply of boats in ports.

According to the invention, the object is achieved by a mounting and a port as described herein.

The mounting according to the invention for a port, preferably a marina, is in particular a pontoon. The mounting is preferably a supply mounting, particularly preferably a supply pontoon. The mounting is preferably configured for connection, in particular fastening, to a landing stage and/or a quay wall. The mounting has a platform. In particular, the platform has a walkway for people to walk on. A receiving body is connected to the platform, in particular underneath. The connection between the platform and the receiving body is preferably form-fit and/or force-fit and/or mate-rial-fit. It is possible, for example, for the platform to be connected to the receiving body in a removable or hinged manner. On the other hand, it is possible in particular for the connection between the platform and the receiving body to be configured as a single piece, also known as integral. The receiving body, in particular the mounting, is preferably configured as a hollow body. The receiving body, in particular the mounting, has a volume, preferably a receiving volume of 1 m³ to 10 m³, preferably of 2 m³ to 5 m³, particularly preferably of approx. 2 m³. The mounting comprises a boat supply arranged inside the receiving body, in particular for supplying power and/or water to a boat. In particular, the mounting and/or the receiving body has a protection class of IP67 or IP68. The receiving body preferably has a front wall, a rear wall and two side walls arranged in between. Preferably, the bottom of the receiving body is also closed off by a bottom wall. At the top, the receiving body is closed off in particular by the platform. The connection between the walls is preferably tight, e.g. by means of a welded seam. The mounting and/or the receiving body preferably has a cross-section in the shape of a square, preferably a trapezoid, particularly preferably an isosceles trapezoid. Preferably, the front wall of the receiving body forms the short trapezoidal side, and the legs of the receiving body form the side walls. The rear wall is preferably configured for arranging the mounting on the port fastening. In particular, the receiving body also has a bottom wall that closes off the receiving body at the bottom. The receiving body is preferably configured to be open at the top, wherein it is preferred that this opening is adapted to be closed with the platform. In particular, the receiving body has a hollow cylindrical shape, preferably closed on one side. In particular, the hollow cylindrical shape has a trapezoidal or rectangular or square cross-section. Preferably, the receiving body and/or the mounting has a polyhedron shape, in particular with a protruding cross-section and/or with eight corners. In particular, with the mounting according to the invention, an integration of the boat supply into the mounting is implemented. The mounting and/or the receiving body particularly has a height of 300 mm to 3000 mm, preferably of 500 mm to 1500 mm, particularly preferably of approx. 900 mm. The mounting and/or the receiving body particularly has a length of 1000 mm to 5000 mm, preferably of 1500 mm to 3000 mm, particularly preferably of approx. 1900 mm. The mounting and/or the receiving body particularly has a depth of 300 mm to 3000 mm, preferably of 500 mm to 1500 mm, particularly preferably of approx. 900 mm. The above dimensions for height, length and depth are maximum dimensions. The measurement axes for the dimensions of height, length and depth are preferably orthogonal to each other.

With the mounting according to the invention, it is in particular advantageously implemented that the boat supply can be arranged in a space-saving and/or unobtrusive manner and/or to minimize the risk, for example the risk of tripping and/or leakage. Preferably, it can be advantageously implemented that the mounting is added as a, preferably modular, addition to existing ports to enable the supply of boats. Preferably, it can be advantageously implemented that the mounting serves as an additional tread surface for stepping onto boats, wherein the mounting can in particular serve as an ascending or descending step relative to the port fastening or is even with the port fastening. Preferably, it can be advantageously implemented that the mounting serves an additional mooring point for boats.

It is preferred that the receiving body is a floating body. In particular, the floating body serves as a floating body for the mounting, so that the mounting floats when it is arranged in water. In particular, the floating body has a buoyancy that makes the mounting buoyant. In the context of the invention, water comprises sweet water and/or salt water.

It is preferred that the mounting is configured to have a draught in the water of at least 10%, preferably at least 30%, particularly preferably at least 50%. A draught of at least 70% or at least 90% is also preferably possible. It is preferred that the receiving body is configured, in particular via a corresponding buoyancy, to implement a corresponding draught. In particular, the weight of the mounting is 50 kg to 1000 kg, preferably 100 kg to 500 kg, particularly preferably approx. 200 kg. The above weight specifications relate in particular to the empty weight of the mounting, i.e. preferably without loading the mounting with waste water and/or fresh water and/or fuel. The mounting and/or the receiving body preferably has a draught, in particular at empty weight, of 50 mm to 2000 mm, preferably of 100 mm to 500 mm, particularly preferably of approx. 170 mm.

It is preferred that the mounting has a fastening device for fastening the mounting to a port fastening, in particular a landing stage and/or a quay wall. In particular, the mounting is a docking system for a port.

It is preferred that the fastening device has a coupling, in particular a detachable coupling, for fastening the mounting to the port fastening in a coupling manner. The coupling is preferably configured, e.g. by means of ropes, for fastening with cleats and/or bollards of the port fastening.

It is preferred that the fastening device is configured for movable fastening of the mounting to the port fastening, in particular in such a way that the mounting is adapted to be moved relative to the port fastening, for example due to water movements. It is preferred that the fastening device has at least one joint for movable fastening.

It is preferred that the mounting has at least one damper, in particular at least one fender. It is preferred that one front wall and/or one or both side walls and/or the rear wall has at least one damper. The at least one damper on the front wall or the side walls serves in particular as an impact protection for boats. The at least one damper on the rear wall serves in particular as an impact protection between the mounting and the port fastening.

It is preferred that the receiving body comprises metal, preferably aluminum, in particular consists thereof. In particular, the aluminum is anodized aluminum and/or marine-grade aluminum. The receiving body can preferably have a basic construction of struts, in particular profiles, e.g. made of metal such as aluminum. The walls of the receiving body consist in particular of metal plates, preferably aluminum plates.

It is preferred that the platform comprises wood, in particular teak, and/or imitation wood. The platform preferably has a slip resistance class of at least R8, preferably R9, particularly preferably R10. The platform can preferably have a basic construction of struts, in particular profiles, e.g. made of metal such as aluminum. One tread surface of the platform particularly comprises boards, preferably made of wood, e.g. teak.

It is preferred that the mounting, preferably the receiving body, has a supply opening for passing a supply line for the boat supply out of the receiving body.

It is preferred that the at least one supply opening is arranged on the side of the mounting and/or the receiving body. Preferably, the at least one supply opening is arranged in a wall, in particular a front wall, of the receiving body. The at least one supply opening is preferably arranged above the draught of the mounting and/or the receiving body. The at least one supply opening is preferably located close to the platform. The at least one supply opening is preferably arranged in the upper half, preferably the upper quarter, particularly preferably the upper eighth of the mounting and/or the receiving body.

It is preferred that the boat supply has at least one supply device. In particular, the at least one supply device is arranged inside the receiving body. Preferably, the boat supply has a waste water device as a supply device. The waste water device is configured for discharging waste water from boats. In a preferred embodiment, the waste water device has a waste water tank for holding boat waste water. The waste water tank is preferably located inside the receiving body. In particular, the waste water tank holds 50 I-1000 I, preferably 100 I-500 I, particularly preferably 180-220 I. In the context of the invention, waste water tanks means in particular gray water tanks and/or black water tanks.

It is preferred that a negative pressure prevails in the waste water tank, in particular compared to the ambient air. Preferably, a negative pressure permanently prevails in the waste water tank. In a preferred embodiment, a negative pressure of −0,1 bar to −1 bar, preferably of −0,3 bar to −0,6 bar, particularly preferably of approx. −0,7 bar, prevails in the waste water tank, in particular relative to the ambient air. It is preferred that the negative pressure is generated by a pump, in particular one arranged inside the receiving body. In particular, the pump is a dooVac pump. Preferably, the pump has a pumping capacity of 20 m³/h and/or a maximum negative pressure of −0.7 bar to be generated. With the negative pressure in the waste water tank it is particularly advantageously implemented that odors and/or leaks do not escape from the waste water tank, or this is reduced. The waste water tank is preferably arranged in a bottom area of the mounting and/or the receiving body. The waste water tank is preferably connected to a waste water shore connection by means of which waste water can be discharged from the waste water tank, in particular pumped out.

It is preferred that the boat supply has at least one of the following supply devices as an alternative or in addition to the waste water device: a fresh water supply for providing fresh water for boats, a fuel supply for providing fuel for boats, and/or a power supply for providing electrical power for boats. In particular, the fresh water supply has a fresh water tank and/or a shore connection for connecting a shore water pipe. In particular, the fuel supply has a fuel tank and/or a shore connection for connecting a fuel line. The fuel tank preferably comprises oil or gasoline or diesel or gas. The power supply preferably has a battery and/or a generator, in particular one connected to the fuel supply.

It is preferred that the boat supply has at least one supply line, in particular a hose and/or a cable. The at least one supply line is configured for connection to a boat and/or for supplying a boat. In particular, the boat supply has one supply line per supply device. The at least one supply line is connected in particular at one end to the supply device. At the other end, the supply line has a boat connection in particular. The boat connection preferably has a valve, in particular a stop valve. The at least one supply line has a length of 10 m to 50 m, preferably of 20 m to 40 m, particularly preferably of approx. 35 m. Preferably, a fresh water hose connected to the fresh water supply is provided with a, preferably adjustable, spray head. The at least one supply line has the particular advantage that boats do not have to carry any lines and/or no lines need to be laid.

It is preferred that the boat connection of the at least one supply line is fixed, in particular in an extendable manner, in the area of the supply opening. This fixation is configured in particular in such a way that the boat connection can be accessed in the area of the supply opening and, for example, the corresponding line can be pulled out. Preferably, after the corresponding boat connection has been returned, in particular uncoupled, it is fixed again in the area of the supply opening. For fixing, the at least one supply line preferably has a thickening, particularly in the area of the boat connection.

In particular, the mounting has one supply opening for each supply device and/or each supply line. Preferably, at least one, preferably a single, supply line is arranged per supply opening.

It is preferred that the boat supply has at least one, in particular automatic, retraction device for retracting the at least one supply line. In particular, the retraction device has a winch, e.g. a self-winding winch. In particular, the retraction device has a motor, preferably for rotating the winch. In particular, the motor is an electric motor that is connected to the power supply of the mounting, for example.

It is preferred that the mounting has at least one seal inside the at least one supply opening for sealing, in particular against water ingress, between the supply opening and the supply line.

It is preferred that the boat supply has at least one meter for measuring the supply, in particular the energy and/or water supply. In particular, the meter is configured to measure a flow rate through the at least one supply line and/or the at least one supply device. The advantage of the meter is that it allows consumption-based recording and, in particular, billing of the supply.

It is preferred that the mounting, in particular the boat supply, has a control unit preferably connected to the meter in a data-transmitting manner. In particular, the control unit comprises a processor. In particular, the control unit is set up and/or configured to control the boat supply. Preferably, the mounting has an emergency switch, in particular one connected to the control unit. The emergency switch is preferably arranged on the outside of the mounting, in particular on the platform. In particular, the emergency switch can be arranged in an opening, preferably one that can be closed.

It is preferred that the control unit is configured for consumption-based billing of the supply based on the measured meter values. Alternatively or additionally, the control unit is configured for communication, in particular wireless communication, with a central server and/or a user device. The user device is, for example, a user's smartphone. It is preferred that the control unit has a module for wireless data transmission for communication, e.g. a modem and/or a Bluetooth module and/or a WiFi module. In particular, the control unit is configured to communicate consumption, costs and/or availability. Alternatively or additionally, the control unit is configured for payment processing of the supply by means of the boat supply. Alternatively or additionally, the control unit is configured to perform a reservation function for the mounting and/or to inform about the availability, in particular existing or planned use, of the mounting.

It is preferred that the mounting, in particular the platform and/or the receiving body, has at least one boat fastening, e.g. a cleat and/or a bollard for fastening boats to the mounting.

It is preferred that the mounting has a water pump for pumping water out of the receiving body. Advantageously, is it thus in particular implemented that water that penetrates the receiving body can be pumped out.

It is preferred that the mounting has at least one lighting device, preferably comprising at least one LED.

It is preferred that the lighting device comprises a platform lighting for illuminating the platform and/or ambient lighting for illuminating the surroundings of the mounting and/or marker lighting for marking the mounting. It is preferred that the control unit is configured to control the lighting device. The control unit is particularly preferably configured to indicate availability, in particular usability, of the mounting by means of the lighting device, e.g. by means of red and green lighting.

It is preferred that the mounting has an access opening, particularly in the platform. The access opening is in particular configured for accessing the inside of the receiving body. The access opening is preferably configured to be lockable and/or closable. Preferably, the access opening is configured for access to the boat supply and/or for access to the control unit, e.g. to an operable operating element of the control unit.

The port according to the invention is in particular a marina. Preferably, it is a marina for leisure boats. The port has at least one port fastening, in particular at least one landing stage and/or at least one quay wall. Furthermore, the port has at least one mounting, preferably several mountings, with one or more features of the mounting according to the invention. The at least one mounting is connected, preferably coupled, to the port fastening.

It is preferred that the mounting is connected to the port fastening in such a way that the platform of the mounting serves as a landing stage for stepping onto a boat arranged on the mounting.

It is preferred that the at least one mounting, in particular the platform, is even or arranged as a descending or ascending step to the port fastening.

It is preferred that the at least one mounting is arranged floating, in particular submerged floating, on the port fastening.

It is preferred that the at least one mounting is arranged at least 10%, preferably at least 30%, particularly preferably at least 50% below the water surface at the port fastening. An arrangement at least 70% or at least 90% below the water surface is also preferably possible. This arrangement defines in particular that the mounting is immersed in water to a corresponding depth. In particular, the mounting is arranged with a draught in the water of at least 10%, preferably of at least 30%, particularly preferably of at least 50% on the port fastening. A draught of at least 70% or at least 90% is also preferably possible. It is preferred that the receiving body is configured, in particular via a corresponding buoyancy, to implement a corresponding draught. In particular, the mounting is connected to the port fastening in such a way that the mounting is submerged to a corresponding depth.

### BRIEF DESCRIPTION OF THE DRAWINGS

In the following, the invention is described in more detail by means of a preferred embodiment with reference to the accompanying drawings.

The terms Fig., Figs., Figure, and Figures are used interchangeably in the specification to refer to the corresponding figures in the drawings.

FIGS. 1-6 show different illustrations of an embodiment of a mounting according to the invention, and

FIG. 7 shows a perspective top view of an embodiment of a port according to the invention having several mountings according to FIGS. 1-6.

### DESCRIPTION OF THE INVENTION

In the Figures, similar or identical components or elements are identified by the same reference numerals or variations thereof (e.g. 10 und 10a). In particular for improved clarity, preferably already identified elements are not provided with reference numerals in all Figures.

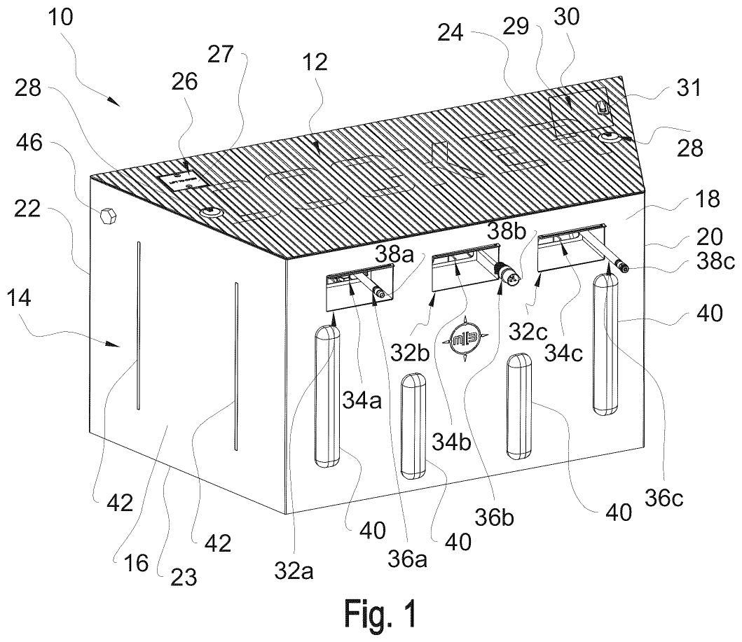

FIG. 1 shows a perspective view pf a mounting 10 according to the invention.

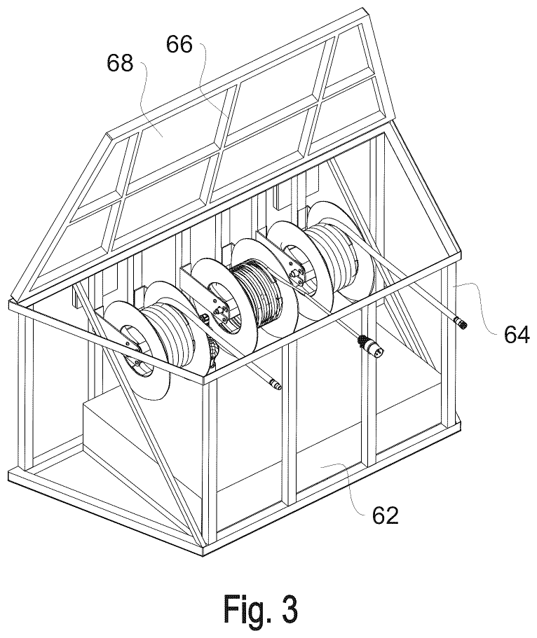

Mounting 10 has a receiving body 14 with two side walls 16, 20 and a front wall 18 and rear wall 22 arranged between them. Receiving body 14 is closed off at the bottom, in particular by a bottom wall 23. In particular, receiving body 14 is configured to be open at the top, wherein the opening is closed by platform 12 (see FIG. 3). Receiving body 14 is shown as a hollow cylinder shape closed on one side with a trapezoidal cross-section.

Two LED strips 42 of a lighting device of mounting 10 are connected to each of the side walls 16, 20 to illuminate the surroundings of mounting 10 and/or as marker lighting.

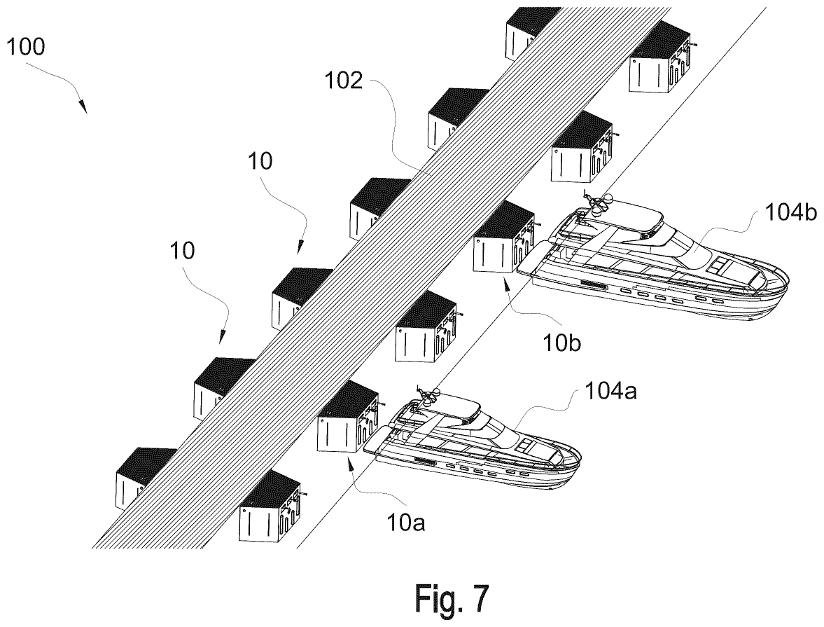

Four dampers 40, in particular fenders, are connected to front wall 16 for shock ab-sorption for boats 104 arranged on mounting 10 (see FIG. 7). Furthermore, an illuminated logo 43 of a lighting device of mounting 10 is arranged on the front wall, in particular optionally.

Platform 12 has several boards 24, preferably made of wood, particularly preferably teak.

Platform 12 has an emergency switch 26 arranged under an openable flap 27 and an access opening 30 closed by an openable flap 29 for accessing the interior or part of the interior of receiving body 14. Flap 29 is configured to be lockable by means of a lock 31.

Two boat fastenings 28 are connected to platform 12 for fastening a boat 104 to mounting 10.

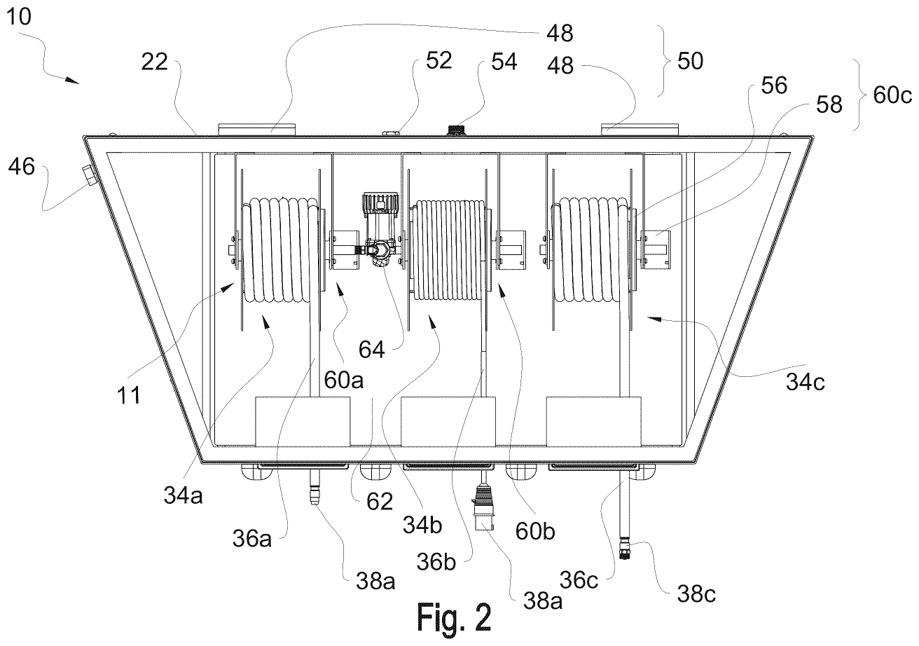

Three supply openings 32a-32c to the interior of receiving body 14 are arranged in an upper area in front wall 16. The supply openings 32a-32c allow access to a boat supply 11 arranged inside the receiving body (see FIG. 2).

FIG. 2 shows a top view of mounting 10 of FIG. 1 without platform 14.

It is illustrated, that boat supply 11 has three supply devices 34a-34c.

Supply device 34a is a waste water supply 34a. Waste water supply 34a has a waste water tank 62 at the bottom of receiving container 14 (see FIG. 3). Waste water tank 62 is connected to a pump 64, which generates, in particular permanently, a negative pressure in waste water tank 62. Furthermore, a waste water hose 36a with boat connection 38a is connected to waste water tank 62 in a fluid-carrying manner. Waste water hose 36a can be used to pump waste water from a boat 104 into waste water tank 62. Waste water tank 62 is furthermore connected to waste water shore connection 46 by means of which waste water can be pumped out of waste water tank 62, in particular when waste water tank 62 is full.

Supply device 34b is a power supply 34b. Power supply 34b has a power cable 36b as supply line 36b. On the one hand, power cable 36 b is connected to a shore power connection 54. On the other hand, power cable 36b is adapted to be connected via a connection 38b to a corresponding boat power connection (not illustrated) for supplying a boat 104 with power. A shore-side power supply cable (not illustrated) can be connected to shore power connection 54.

Supply device 34c is a fresh water supply 34c. Fresh water supply 34c has a fresh water hose 36c as supply line 36c. On the one hand, fresh water hose 36c is connected to a fresh water shore connection 52. On the other hand, fresh water hose 36c is adapted to be connected via a connection 38c to a corresponding (not illustrated) fresh water tank of a boat 104 for supplying fresh water to boat 104. A shore-side power supply cable (not illustrated) can be connected to fresh water shore connection 52.

The supply lines 36a-36c are extendable in the area of the access openings 34a-34c (see FIG. 1). Furthermore, the supply lines 36a-36c are configured to be retractable, in particular rollable, by means of retraction devices 60a-60c. For this purpose, the retraction devices have winches 56 driven by motors 58 for automatically rolling up the supply lines 36a-36c.

A fastening device 50 having two connectors 48 is connected to rear wall 22 for fastening mounting 10 to a port fastening 102 (see FIG. 7), in particular in a detachable manner.

Preferably, boat supply 11 has at least one meter (not illustrated) for recording the consumption of the supply from the supply devices 34a-34c. Preferably, a meter for recording the waste water discharged from a boat 104 by waste water device 34a, and/or a meter for recording the fresh water supplied to a boat 104 by fresh water supply 34c, and/or an electricity meter for recording the consumed electricity of a boat 104 is provided.

Preferably, mounting 10 also has a control unit (not illustrated). The control unit is preferably connected to the at least one meter in a data-transmitting manner. In particular, the control unit is configured for consumption-based billing of the supply based on the measured meter values of the at least one meter and/or for communication, in particular wireless communication, with a central server and/or a user device and/or for payment processing of the supply by means of the boat supply. For communication, the control unit can in particular have at least one, preferably wireless, data transmission device, e.g. a modem and/or a Bluetooth module and/or a WiFi module. In particular, a boatman and/or port operator can in particular communicate with the control unit in this way. The control unit, or at least a part of the control unit, can preferably be arranged in the area of access opening 30.

FIG. 3 shows a perspective view of mounting 10 of FIG. 1 with hidden walls 16, 18, 20, 22, 23 and a hidden tread surface 68 with boards 24.

A basic construction of receiving body 14 consists of several profiles 64, in particular made of aluminum or steel. A basic construction of platform 12 consists of several profiles 68, in particular made of aluminum or steel.

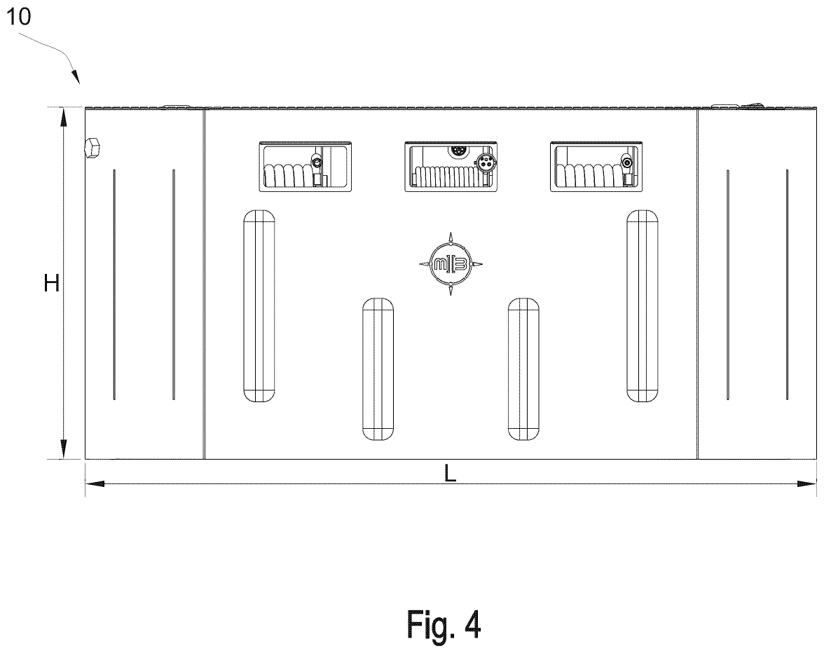

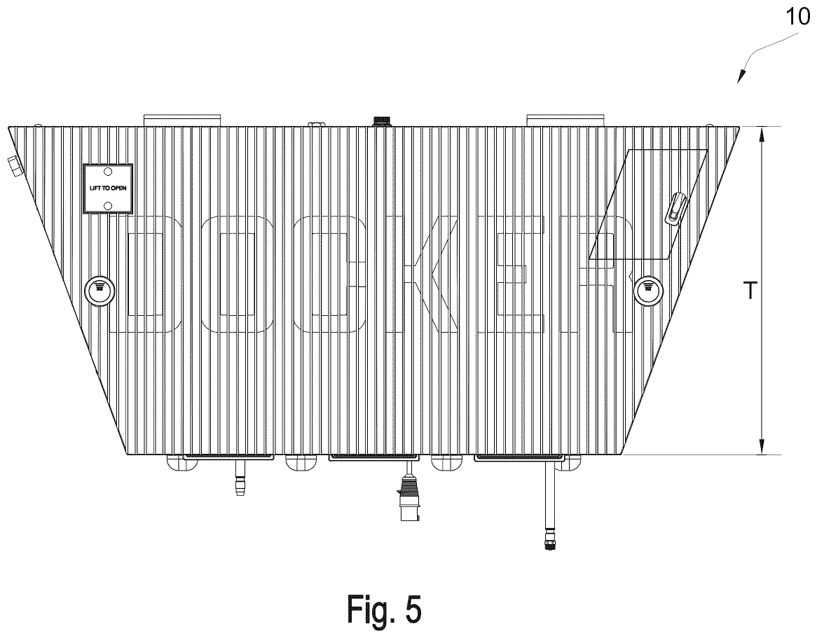

FIG. 4 shows a front view and FIG. 5 shows a top view of mounting 10 of FIG. 1.

FIGS. 4-5 show the height H, the length L and the depth T of mounting 10.

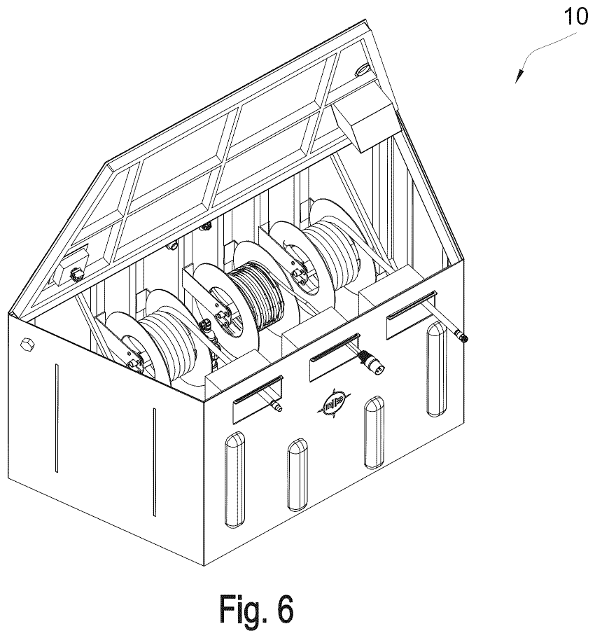

FIG. 6 shows a view of mounting 10 of FIG. 1 with platform 12 open.

FIG. 7 shows an embodiment of a port 100 according to the invention having a plurality of mountings 10, 10a, 10b connected to a port fastening 102 according to the embodiment of FIG. 1. Port fastening 102 is in particular a landing stage or a quay wall. The mountings 10, 10a, 10b are immersed in the water of port 100 so that they have a draught.

Respectively one boat 104a, 104b is arranged on mounting 10a and mounting 10b to supply the respective boat 104a, 104b.

The platforms 12a, 12b of the mountings 10a, 10b serve as additional landing stages for stepping onto and/or mooring the boats 104a, 104b.

1. A mounting, in particular a pontoon, for a port, comprising
a platform,
a receiving body arranged under the platform,
a boat supply arranged inside the receiving body, in particular for supplying power and/or water to a boat.

2. The mounting according to claim 1, the receiving body is a floating body, in particular for the mounting.

3. The mounting according to claim 1, wherein the mounting is configured to have a draught in the water of at least 10%, preferably at least 30%, particularly preferably at least 50%.

4. The mounting according to claim 1, further including a fastening device for fastening the mounting to a port fastening, in particular a landing stage and/or a quay wall.

5. The mounting according to claim 4, wherein the fastening device has a coupling, in particular a detachable coupling, for fastening the mounting to the port fastening in a coupling manner.

6. The mounting according to claim 4, wherein the fastening device is configured for movable fastening of the mounting to the port fastening, in particular in such a way that the mounting is adapted to be moved relative to the port fastening, for example due to water movements.

7. The mounting according to claim 1, further comprising at least one damper, in particular a fender.

8-9. (canceled)

10. The mounting according to claim 1, comprising at least one supply opening for passing a supply line of the boat supply out of the receiving body.

11. The mounting according to claim 10, wherein the at least one supply opening is arranged in a wall, in particular a front wall, of the receiving body.

12. The mounting according to claim 1, wherein the boat supply comprises a waste water tank for receiving boat waste water.

13. The mounting according to claim 12, wherein the waste water tank is under negative pressure, preferably via a pump.

14. The mounting according to claim 1, wherein the boat supply comprises at least one of the following supply devices:
a fresh water supply for providing fresh water for boats,
a fuel supply for providing fuel for boats, and/or
a power supply for providing electrical power for boats.

15. The mounting according to claim 1, wherein the boat supply comprises at least one supply line, in particular a hose and/or cable.

16. The mounting according to claim 15, wherein a boat connection of the at least one supply line is fixed, in particular extendable, in the region of the supply opening.

17. The mounting according to claim 15, further comprising an automatic, retraction device for retracting the at least one supply line.

18. The mounting according to claim 1, wherein the boat supply comprises at least one meter for measuring the supply.

19. The mounting according to claim 18, further comprising a control unit preferably connected to the meter in a data-transmitting manner.

20. The mounting according to claim 19, wherein the control unit is configured at least for:
consumption-based billing of the supply based on the meter readings,
communication, in particular wireless communication, with a central server and/or a user device, and/or
payment processing of the supply via the ship supply.

21. The mounting according to claim 1, further comprising at least one boat fastening, for example a cleat and/or a bollard.

22. The mounting according to claim 1, further comprising a water pump for pumping water out of the receiving body.

23-29. (canceled)
